(19) United States
(12) Patent Application Publication
(10) Pub. No.: US 2023/0418852 A1
(43) Pub. Date: Dec. 28, 2023

(54) QUESTION-ANSWERING SYSTEM FOR AUTONOMIC MANAGEMENT

(71) Applicant: INTERNATIONAL BUSINESS MACHINES CORPORATION, Armonk, NY (US)

(72) Inventors: MUDHAKAR SRIVATSA, White Plains, NY (US); Dinesh C. Verma, New Castle, NY (US); SATISH SADAGOPAN, Leawood, KS (US); Mathews Thomas, Flower Mound, TX (US); Utpal Mangla, Toronto (CA)

(21) Appl. No.: 17/846,115

(22) Filed: Jun. 22, 2022

(51) Int. Cl. G06F 16/332; G06F 40/30; G06Q 10/06

(52) U.S. Cl. CPC G06F 16/3329; G06F 40/30; G06Q 10/06393

(57) ABSTRACT

Disclosed are methods method, systems, and computer program products for automatic management of a data processing system (DPS). One embodiment of the method may comprise receiving, at a computer processor, operations data associated with a DPS; and generating, by a Question-Answer (QA) system executing on the computer processor, a Question sentence from the operations data. The method may further comprise sampling a window of the operations data, extracting a plurality of key performance indicators (KPI) from the operations data in the sampled window, and providing the plurality of KPI to the QA system.

### BACKGROUND

The present disclosure relates to autonomic systems of data processing systems (DPS), and more specifically, to techniques for using question-answer (QA) systems to enable autonomic management.

The development of the EDVAC system in 1948 is often cited as the beginning of the computer era. Since that time, computer systems have evolved into extremely complicated devices. Today's computer systems typically include a combination of sophisticated hardware and software components, application programs, operating systems, processors, buses, memory, input/output devices, and so on. As advances in semiconductor processing and computer architecture push performance higher and higher, even more advanced computer software has evolved to take advantage of the relatively higher performance of those capabilities, resulting in computer systems today that are more powerful than just a few years ago.

These increased capabilities, unfortunately, have been accompanied by increased complexity. This complexity, in turn, has made it difficult to diagnose issues, or otherwise manage, those computer systems.

### SUMMARY

According to embodiments of the present disclosure, a method for automatic management of a data processing system (DPS), the method comprising receiving, at a computer processor, operations data associated with a DPS; and generating, by a Question-Answer (QA) system executing on the computer processor, a Question sentence from the operations data. The method may further comprise sampling a window of the operations data, extracting a plurality of key performance indicators (KPI) from the operations data in the sampled window, and providing the plurality of KPI to the QA system.

According to embodiments of the present disclosure, a system for automatic management of a data processing system (DPS), the system comprising: a logging system adapted to receive operations data for the DPS, and a Question-Answer (QA) generation pipeline adapted to generate a Question sentence from the operations data. In some embodiments, the QA pipeline may be further adapted to sample a window of the operations data, extract a plurality of key performance indicators (KPI) from the operations data in the sampled window, and provide the plurality of KPI to the QA system.

According to embodiments of the present disclosure, a computer program product, comprising a computer readable storage medium having program instructions embodied therewith. The program instructions may be executable by a computer to cause the computer to perform a method for automatic management of a data processing system (DPS). The method may comprise receiving operations data associated with a DPS, wherein the wherein the operations data comprises event logs and performance metrics from an operational DPS, sampling a window of the operations data, extracting a plurality of key performance indicators (KPI) from the operations data in the sampled window, and providing the plurality of KPI as a pseudo language input sentence to a Question-Answer (QA) system. The method may further comprise generating, by the QA system, a Question sentence from the operations data and generating, by the QA system, an Answer sentence responsive to the Question sentence. The Answer sentence may comprise a script adapted to perform a remediation action for a fault identified in the Question sentence, and the method may further comprise automatically executing the script.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates one embodiment of a data processing system, consistent with some embodiments.

FIG. 2 illustrates one embodiment of a cloud environment comprising one or more DPS 100, consistent with some embodiments.

FIG. 3 shows a set of functional abstraction layers provided by a cloud computing environment, consistent with some embodiments.

FIG. 4A illustrates an example ML model 400, consistent with some embodiments.

FIG. 4B depicts one embodiment of a ML model training method 450, consistent with some embodiments and described with reference to answer generation as an illustrative example.

FIGS. 5A-5B (collectively FIG. 5) are a system diagram of a QA generation pipeline that may be enabled in an autonomic management system, consistent with some embodiments.

FIG. 6 is a flow chart showing one method using a QA generation pipeline to automate management of DPS, consistent with some embodiments.

FIG. 7 is an attention statement provided for explanatory purposes.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to autonomic systems of data processing systems (DPS); more particular aspects relate to techniques for using question-answer (QA) systems to enable autonomic management. While the present disclosure is not necessarily limited to such applications, various aspects of the disclosure may be appreciated through a discussion of various examples using this context.

Many DPS, particularly those at the network edge, collect enormous amounts of operations data, such as real-time performance metrics and/or real-time event logs, that system administrators can use diagnose impending and/or actualized faults, and then perform remediation actions. Such manual diagnosis and remediation, however, typically requires considerable amounts of time and expertise. Accordingly, some embodiments of the present disclosure may provide an autonomic management system that uses big data, analytics, and artificial intelligence to do one or more of the following: (i) collect and aggregate the large volume of operations data generated by a DPS and/or system of multiple DPS; (ii) intelligently sift ‘signals’ out of the ‘noise’ to identify events and patterns related to performance and availability issues; and (iii) diagnose and report root causes to the system administrators for rapid response and remediation—or, in some embodiments, to automatically remediate these issues without human intervention. By supplementing, or even replacing, traditional manual system administrations using these techniques, some embodiments may enable quicker (or even proactive) responses to slowdowns and outages, with less manual effort. In this way, some embodiments may be useful by bridging the gap between an increasingly diverse, dynamic, and difficult-to-monitor information technology landscape on the one hand, and meeting user expectations for little or no interruption in application performance and availability on the other.

One aspect of this disclosure is a method for automatically analyzing operations data produced by the DPS and/or systems of DPS, diagnosing whether (or not) there are any faults suggested by that data, and then automatically generating remediation actions. Some embodiments may include an autonomic management method for DPS and/or systems of DPS that use AI to perform the diagnose and/or to localize faults, and then recommend and/or automatically implement solutions to those faults.

The AI in some embodiments may comprise a question-answering (QA) system. In particular, some embodiments may include using the QA system to automatically extract a succinct “Question” sentence from the raw operations data collected from an operational DPS (and/or group of multiple DPS that comprise a larger system), and then automatically generate one or more “Answer” sentences to the “Question” sentence. These Answer sentences may comprise a remediation action in the form of a shell script customized for the diagnosed fault. The generated remediation action(s) may be presented to an administrator of the DPS, or may automatically be performed by the system.

The QA systems in such embodiments are not merely search engines. While a search engine (e.g., an Internet web search engine) typically has access to an immense source of information and can quickly find relevant results (e.g., web pages) given a small number of query terms, search engines do not return answers to specific questions; rather, search engines return a ranked list of results (e.g., web pages) that the user may be trying to find. QA systems in some embodiments, in contrast, take questions formulated in a pseudo-language as input, and then generate an answer to the input question, together with a confidence measure as to how accurate that answer is with respect to the input question. The output of the QA system may also include summaries of justifying/supporting evidence, which may enable the system administrator to quickly assess its recommended actions.

Some embodiments of the disclosure may apply sentence extraction and/or shortening techniques to the performance metrics, events, error messages, etc. generated and/or logged by a logging system of a DPS for purposes of debugging, performance monitoring, metering and billing, etc. (“operational data”). Most operational DPS and/or groups of DPS gather huge volumes of system monitoring data, typically thousands of metrics/log entries per second. Using this volume of information in raw form would result in a very long input to the QA system (“Question sentence”), many times longer than is typically analyzed by QA systems. To reduce that volume of information, some embodiments may encode the operational data. This may include employing dimensionality reduction (i.e., sentence length shortening) techniques to encode the system monitoring data. These dimensionality reduction techniques may include, without limitation: (i) PAA-SAX (Piecewise Aggregate Approximation/Symbolic Aggregate Approximation); (ii) anomaly detectors in the temporal domain (such as ARIMA, Holt-Winters, BATS); and/or (iii) anomaly detectors in the spatial domain (such as PCA—Principal Component Analysis and Auto-Encoders). In one embodiment, the dimensionality reduction may include identifying a plurality of key performance indicators (KPI) in the raw operational data that each exhibit a particular anomaly, and then analyzing the time series of those KPIs. The analysis, in turn, may comprise sampling the identified KPIs during a time window, and then treating the resulting string of KPIs as the input Question sentence to the QA system. In this way, some embodiments may generate a pseudo-language specific to the managed DPS and/or system of DPS. That is, using the above approach, some embodiments can reduce monitoring data into a smaller string of symbols (i.e., the KPIs) that are (or are not) anomalous in a particular time window. These shortened pseudo-language sentences can then be treated as the input to the QA system. The QA system, in turn, may then generate an Answer question in the form of a control action that should be taken in response to a specific input Question sentence (e.g., when the sampled KPIs show a change in behavior indicating that the state of the DPS and/or network is changing and/or has changed, then the Answer may be the associated remediation action). In this way, some embodiments may bridge the impedance mismatch between the volume of data generated by typical DPS and/or network systems, and the design inputs for typical QA systems.

The control action may comprise a notification sent to a system administrator via text or email in some embodiments that contains a summary of the problem in the Question sentence and a recommended remediation action. In other embodiments, the control action may comprise a shell script that is designed to remediate the problem defined in the Question sentence. This shell script may be automatically executed by the DPS in some embodiments, and may be viewed as a second pseudo-language (i.e., the QA system translates between the first pseudo language—the string of KPIs—to a second pseudo-language—the shell script). In this way, some embodiments may be adapted to automatically and continuously diagnosis anomalies, then may automatically generate remediation actions in response to the detected anomalies, and then may automatically execute that remediation action.

### Data Processing System (DPS)

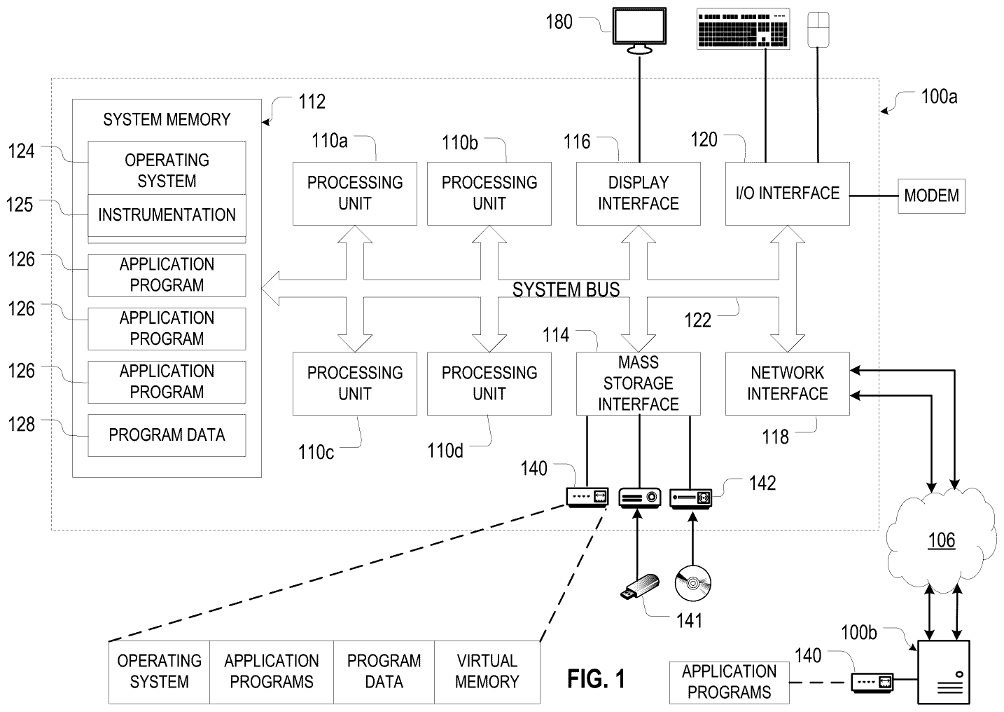

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, PDA (Personal Digital Assistant), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and that the number, type, and configuration of such components may vary.

The DPS 100 in FIG. 1 may comprise a plurality of processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interfaces 114 in this embodiment may connect the system bus 122 to one or more mass storage devices, such as a direct access storage device 140, a USB drive 141, and/or a readable/writable optical disk drive 142. The network interfaces 118 may allow the DPS 100a to communicate with other DPS 100b over a network 106. The main memory 112 may contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the computing systems 100 may only comprise a single processor system and/or a single processor designed to emulate a multiprocessor system. Further, the processor(s) 110 may be implemented using a number of heterogeneous data processing systems 100 in which a main processor 110 is present with secondary processors on a single chip. As another illustrative example, the processor(s) 110 may be a symmetric multiprocessor system containing multiple processors 110 of the same type

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices, which are in communication with the processor(s) 110 through the system bus 122. The program code in the different embodiments may be embodied on different physical or tangible computer-readable media, such as the memory 112 or the mass storage devices. In the illustrative example in FIG. 1, the instructions may be stored in a functional form of persistent storage on the direct access storage device 140. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage device(s) 140 may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts that the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like. The I/O interface 120 may support attachment of one or more I/O devices, such as a keyboard 181, mouse 182, modem 183, or printer (not shown)

The terminal/display interface 116 may be used to directly connect one or more displays 180 to the data processing system 100. These displays 180 may be non-intelligent (i.e., dumb) terminals, such as an LED monitor, or may themselves be fully programmable workstations that allow IT administrators and users to communicate with the DPS 100. Note, however, that while the display interface 116 may be provided to support communication with one or more displays 180, the computer systems 100 does not necessarily require a display 180 because all needed interaction with users and other processes may occur via the network 106.

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “InfiniBand” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

The operating system 124 may include one or more instrumentation subsystems 125 (only one depicted for clarity) that may monitor the operation of the DPS 100, its hardware (e.g., the processor(s) 110; the main memory 112; the interface(s) 114, 116, 118, 120), the application programs 126, etc. These instrumentation subsystems 125 may generate operational data (e.g., performance metrics and/or event logs) periodically and/or in response to events that occur in the DPS 100.

### Cloud Computing

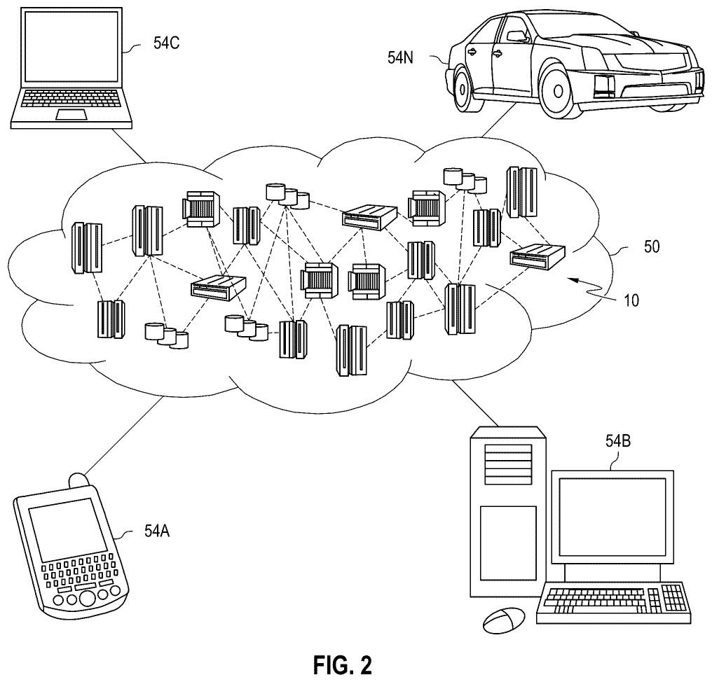

FIG. 2 illustrates one embodiment of a cloud environment comprising a plurality of DPS, such as DPS 100. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

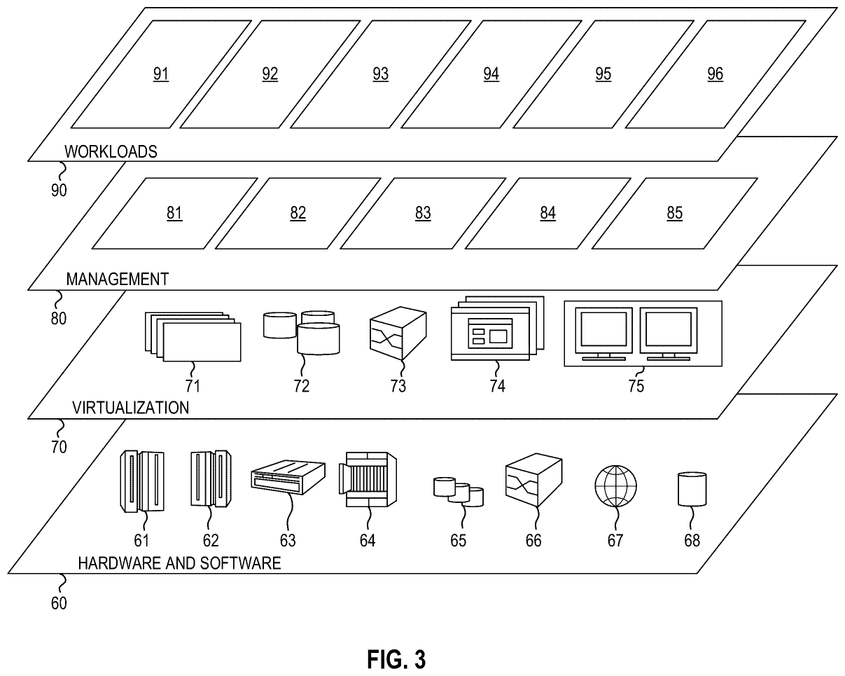

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and autonomic management system 96.

### Artificial Intelligence

The AI system in some embodiments may comprise one or more machine learning models (ML models). The ML models, in turn, may be any software system that recognizes patterns. In some embodiments, the ML models comprise a plurality of artificial neurons interconnected through connection points called synapses or gates. Each synapse may encode a strength of the connection between the output of one neuron and the input of another. The output of each neuron, in turn, may be determined by the aggregate input received from other neurons that are connected to it, and thus by the outputs of these “upstream” connected neurons and the strength of the connections as determined by the synaptic weights.

The ML models may be trained to solve a specific problem (e.g., QA pair generation from a question formed from the output of the instrumentation subsystem 125, etc.) by adjusting the weights of the synapses such that a particular class of inputs produce a desired output. This weight adjustment procedure in these embodiments is known as “learning.” Ideally, these adjustments lead to a pattern of synaptic weights that, during the learning process, converge toward an optimal solution for the given problem based on some cost function. In some embodiments, the artificial neurons may be organized into layers.

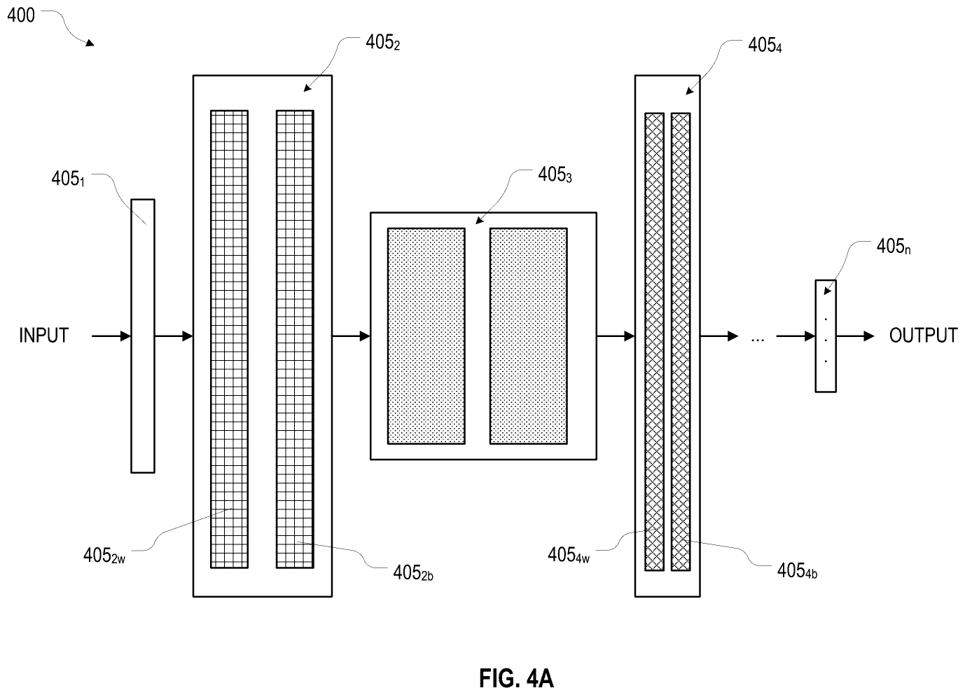

FIG. 4A illustrates an example ML model 400, consistent with some embodiments. The ML model 400 comprises a plurality of layers 4051-405n. Each of the layers comprises weights 4051w-405nw and biases 4051b-405nb (only some labeled for clarity). The layer 4051 that receives external data is the input layer. The layer 405n that produces the ultimate result is the output layer. Some embodiments include a plurality of hidden layers 4052-405n-1 between the input and output layers, and commonly hundreds of such hidden layers. Some of the hidden layers 4052-405n-1 may have different sizes, organizations, and purposes than other hidden layers 4052-405n-1. For example, some of the hidden layers in the ML model may be convolution layers, while other hidden layers may be fully connected layers, deconvolution layers, or recurrent layers.

Referring now to FIG. 4B, one embodiment of a ML model training method 450 is depicted, consistent with some embodiments and described with reference to answer generation as an illustrative example. At operation 452, the system receives and loads training data. In this example, the input data-set may include questions formed from previous output of the instrumentation subsystem 125, together with timestamped problems diagnosed by system administrators and/or any remediation actions performed. At operation 454, the training data is prepared to reduce sources of bias, typically including de-duplication, normalization, and order randomization. At operation 456, a model is selected for training and the initial synaptic weights are initialized (e.g., randomized). Depending on the underlying task, suitable models include, but are not limited to, feedforward techniques (e.g., convolutional neural networks), regulatory feedback-based systems, radial basis function (RBF) techniques, and recurrent neural network-based techniques (e.g., long short-term memory). At operation 458, the selected model is used to predict an output using the input data element, and that prediction is compared to the corresponding target data. A gradient (e.g., difference between the predicted value and the target value) is then used at operation 460 to update the synaptic weights. This process repeats, with each iteration updating the weights, until the training data is exhausted, or the model reaches an acceptable level of accuracy and/or precision. At operation 462, the resulting model may optionally be compared to previously unevaluated data to validate and test its performance.

Some embodiments may advantageously utilize encoder decoder architecture based on attention layers to recognize dependencies in the input data. One such system is a transformer neural network. These embodiments may be desirable because they may recognize relatively longer range dependencies, which may help address vanishing gradient problems using multi-headed attention, making these embodiments potentially more effective in handling long range dependencies. That is, for purposes of explanation, while embodiments using, e.g., Long Short-Term Memory (LSTM) may successfully associate the question sentence “The clouds are in the ______” as having the answer “sky” because the distance between “clouds” and the predicted word “sky” is small; in contrast, embodiments using transformer networks may successfully handle much longer distances, e.g., associate the question sentence “I grew up in Germany with my parents, I spent many years there and have proper knowledge about their culture, that's why I speak fluent ______” with the answer “German.”

### QA Generation Pipeline

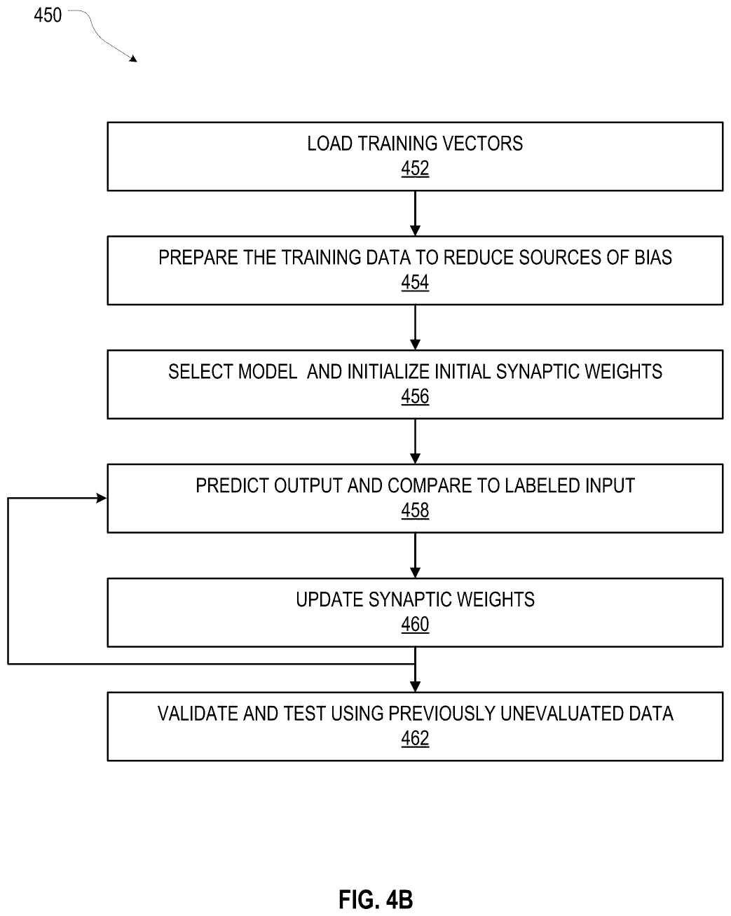

FIGS. 5A-5B (collectively FIG. 5) are a system diagram of a QA generation pipeline 500 that may be enabled in the autonomic management system 96, consistent with some embodiments. This QA generation pipeline 500 may comprise four subsystems: a sentence extraction subsystem 505, a question generation (QG) subsystem 510, an answer generation (AG) subsystem 520, and ranking subsystem 530. In operation, the QA generation pipeline 500 may receive one or more streams of raw operational data 501 from the instrumentation subsystem 125 (see FIG. 1). This raw operational data may be encoded into pseudo-language sentences (e.g., a sequences of key performance indicator anomalies 540, or KPI anomalies, only some labeled for clarity) of configurable length by the sentence extraction subsystem 505. The QG subsystem 510 may then analyze the resulting string(s) of KPIs 540 to generate a pseudo-language Question 550 reflecting any current anomalies associated with the monitored system. The AG subsystem 520 may then generate one or more Answers 555 to each generated Question 550. These Answers 555 may each comprise a recommended remediation action to be sent to the human administrators of the system by mail or text and/or may comprise scripts 560 that may be executed to directly remediate the anomaly. The ranking subsystem 530 may rank the generated Answers 555 and select a highest ranking answer to be automatically implemented by the managed system e.g., DPS 100. In this way, some embodiments of the disclosure may automatically formulate and execute management tasks using the QA generation pipeline 500.

The sentence extraction subsystem 505, the QG subsystem 510, the AG subsystem 520, and the ranking subsystem 530 may comprise one or more ML models, such as transformer neural networks, to automatically generate the pseudo-language Questions 550 and associated Answers 555. The sentence extraction subsystem 505 may comprise a first ML module that, e.g., identifies temporal or spatial anomalies in the streams of operational data 501. The QG subsystem 510 may comprise a second ML model that parses output of the sentence extraction subsystem 505, identifies key facts and relationships, and generates a pseudo-language Question 550. The 550 AG subsystem 520 may comprise a third ML model that takes the generated, pseudo-language Question sentence and previous manual interventions by system administrators as input, and then generates one or more solutions to that match that Question 550. The solutions may be in the form of an Answer 555, and may be repeated multiple times for each Question 550, forming a plurality of QA pairs. The ranking subsystem 530 may comprise a fourth ML model that ranks the QA pairs, both in terms of relative importance (e.g., what would a typical IT staff member find important in the input data) and in terms of effectiveness of the past solutions.

In this way, the monitored DPS 100 and/or system can be thought of as speaking a unique, non-human pseudo language whose symbols are the KPI anomalies 540. Advantageously, if the operational data 501, projected to KPI anomalies 540, is treated as a source pseudo language and associated remediation actions as a target pseudo language, the ML model(s) described above may translate between two pseudo languages. Additionally, the explanations generated by the transformer ML model, may include which terms of source pseudo language (e.g., specific KPI anomalies 540) that were most influential for the recommended action (an orchestration action or a prioritization action) may be output.

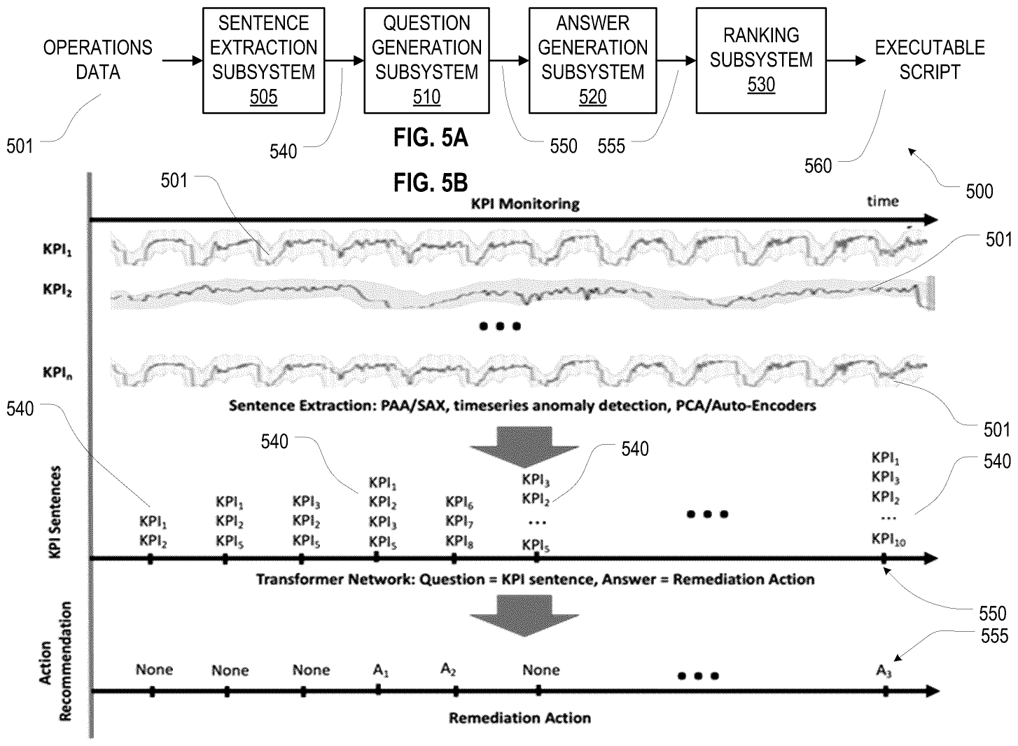

FIG. 6 is a flow chart showing one method 600 using the QA generation pipeline 500 to automate management of a DPS, consistent with some embodiments. At operation 605, the sentence extraction subsystem 505 may receive operational data 501 from the instrumentation 125 and then extract a plurality of symbols (e.g., KPI 540) from that operational data 501, producing a single, relatively lower bandwidth signal. In embodiments using metric data from instrumentation 125, such features may be extracted using one or more of: (i) temporal anomalies, identified using, e.g., univariate or multivariate anomaly detection algorithms; (ii) spatial anomalies, identified using, e.g., principal component analysis or auto-encoders); and (iii) spatiotemporal anomalies, identified using, e.g., recurrent auto-encoders. The temporal anomalies, in turn, may essentially capture mismatches between x(t+1) given x(t), x(t−1), etc.; and the spatial anomalies may essentially capture mismatch between x(t), y(t), z(t), etc., where x, y, and z are metrics captured by the system. Similarly, in embodiments using log data from instrumentation 125, such features may be extracted using log template extraction and capture spatial anomalies on co-occurrence of log templates, identified using, e.g., principal component analysis or auto-encoders; or on spatiotemporal anomalies, identified using, e.g., recurrent auto-encoders.

At the end of operation 605, the large volume of metric and/or log data from the instrumentation 125 may have been converted into a sequence of categorical symbols, or KPI 540 (e.g., with each symbol representing a particular metric or log anomaly). This string of symbols may comprise a first pseudo language customized for the particular DPS 100 (e.g., a network edge device) or system (e.g., cloud environment 50). At operation 610, the question generation (QG) subsystem 510 may extract a Question 550 from the sequence of symbols, analyzed over a window of configurable length. The length of this window may also be parameterizable to increase/decrease the length of the Question 550 in some embodiments (e.g., to increase statistical confidence in detected anomalies, to reduce the number of anomalies in a question sentence, etc.). In this way, some embodiments may provide an ability to extract a succinct Question 550 from a large volume of raw metric/log data. This Question 550 may be in a second pseudo language.

At the end of operation 610, a succinct pseudo-language Question 550 may have been extracted. The Question 550 sentence may then be analyzed by the AG subsystem 520 using a question-answering approach at operation 615. This may include the AG subsystem 520 translating the Question 550 in the second pseudo-language (e.g., in a “network” language for network devices) to an Answer 555 in a third pseudo-language (e.g., a sequence of remediation actions in the form of a shell script 560).

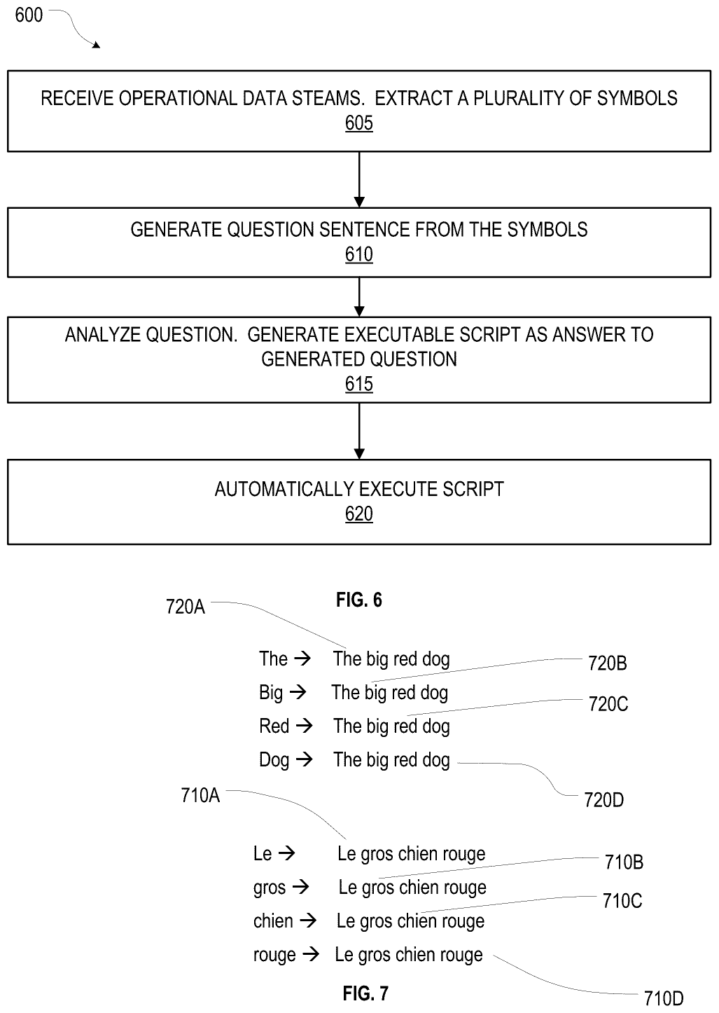

In some embodiments, the AG subsystem 520 may comprise a transformer neural network. The use of such multi-headed attention-based approaches may help ensure that each such remediation action can be explained using the symbols in the Question 550. While these symbols may be primarily directed for use by the QA generation pipeline 500 to enable closed loop automation, they may also be interpretable by a skilled domain expert (e.g., human system administrator) to provide end-to-end explain-ability e.g., for purposes of auditability, further refinement of the pipeline, etc. For clarity of explanation only, an example of such an attention statement is shown in FIG. 7 for language translation from English to French. In this simplified example, each symbol (word) in French 710A-710D is related via attention to symbols (words) in English 720A-720D. In a similar manner, each remediation action (output pseudo-language) in some embodiments may be associated with one more tokens (e.g., metric/log anomalies) in the pseudo-input language.

Once the remediation action (along with attention-based explanation) is produced by the transformer neural network, the action can be recommended to the subject matter expert or automatically performed at operation 620. In some embodiments, the QA generation pipeline 500 may initially bias toward notification. However, over time, the relatively more popular and/or successful recommendations may be automated while only soliciting human input on relatively rarer actions.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a subsystem, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### General

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Therefore, it is desired that the embodiments described herein be considered in all respects as illustrative, not restrictive, and that reference be made to the appended claims for determining the scope of the invention.

What is claimed is:

1. A method for automatic management of a data processing system (DPS), the method comprising:
receiving, at a computer processor, operations data associated with a DPS; and
generating, by a Question-Answer (QA) system executing on the computer processor, a Question sentence from the operations data.

2. The method of claim 1, further comprising:
sampling a window of the operations data;
extracting a plurality of key performance indicators (KPI) from the operations data in the sampled window; and
providing the plurality of KPI to the QA system.

3. The method of claim 2, wherein providing the plurality of KPI in the sampled window comprise a pseudo language input sentence to the QA system.

4. The method of claim 1, wherein the question sentence represents an anomaly in the operations data.

5. The method of claim 4, wherein the anomaly comprises a temporal anomaly.

6. The method of claim 4, wherein the anomaly comprises a spatial anomaly.

7. The method of claim 4, wherein the anomaly comprises a spatiotemporal anomaly.

8. The method of claim 1, further comprising generating, by the QA system, an Answer sentence responsive to the Question sentence.

9. The method of claim 8, wherein the Answer sentence identifies a remediation action for a fault identified in the Question sentence.

10. The method of claim 9, wherein the Answer sentence comprises a script executable on the DPS.

11. The method of claim 10, further comprising automatically executing the script.

12. The method of claim 1, wherein the operations data comprises performance metrics of an operational DPS.

13. The method of claim 1, wherein the operations data comprises event logs and performance metrics from an operational DPS.

14. A system for automatic management of a data processing system (DPS), the system comprising:
a logging system adapted to receive operations data for the DPS; and
a Question-Answer (QA) generation pipeline adapted to generate a Question sentence from the operations data.

15. The system of claim 14, wherein the QA pipeline is further adapted to:
sample a window of the operations data;
extract a plurality of key performance indicators (KPI) from the operations data in the sampled window; and
provide the plurality of KPI to the QA system.

16. The system of claim 15, wherein providing the plurality of KPI in the sampled window comprise a pseudo language input sentence to the QA system.

17. The system of claim 14, wherein the QA generation pipeline is further adapted to generate an Answer sentence responsive to the Question sentence.

18. The system of claim 17, wherein the Answer sentence identifies a remediation action for a fault identified in the Question sentence.

19. The system of claim 14, wherein the operations data comprises event logs and performance metrics from the DPS.

20. A computer program product, comprising a computer readable storage medium having program instructions embodied therewith, the program instructions being executable by a computer to cause the computer to perform a method for automatic management of a data processing system (DPS), the method comprising:
receiving operations data associated with a DPS, wherein the operations data comprises event logs and performance metrics from an operational DPS;
sampling a window of the operations data;
extracting a plurality of key performance indicators (KPI) from the operations data in the sampled window; and
providing the plurality of KPI as a pseudo language input sentence to a Question-Answer (QA) system;
generating, by the QA system, a Question sentence from the operations data;
generating, by the QA system, an Answer sentence responsive to the Question sentence, wherein the Answer sentence comprises a script adapted to perform a remediation action for a fault identified in the Question sentence; and
automatically executing the script.
